(19) United States
(12) Patent Application Publication
(10) Pub. No.: US 2021/0100260 A1
(43) Pub. Date: Apr. 8, 2021

(54) FILM, PACKAGE AND METHOD FOR CHEESE RIPENING AND PRESERVATION

(71) Applicant: Cryovac, LLC, Charlotte, NC (US)

(72) Inventors: Eirini Stafyla, RHO (MI) (IT); Romano Spigaroli, Legnano (MI) (IT); Daniela Garavaglia, Busto Garolfo (MI) (IT); Monica Picariello, Milano (IT)

(21) Appl. No.: 16/497,570

(22) PCT Filed: Apr. 5, 2018
(86) PCT No.: PCT/EP2018/058756

§ 371 Date: Sep. 25, 2019

(30) Foreign Application Priority Data
Apr. 6, 2017 (EP) 17165370.2

(51) Int. Cl. A23C 19/16; B65D 65/46; B32B 27/36; B32B 9/02; B32B 9/04; B65D 65/40; B65D 85/76; B65B 25/06; B65B 53/02; B65D 75/00; A23C 19/097

(52) U.S. Cl. CPC A23C 19/166; B32B 2439/70; B32B 27/36; B32B 9/02; B32B 9/045; B65D 65/40; B65D 85/76; B65B 25/068; B65B 53/02; B65D 75/002; A23C 19/097; B32B 2307/7244; B32B 2307/7246; B32B 2307/518; B32B 2307/736; B32B 2250/40; B32B 2250/03; B32B 2307/7163; B32B 2307/51; B32B 2307/54; B65D 65/466

(57) ABSTRACT

The present invention relates to a method, to a biodegradable film and to a package for cheese ripening or preservation, in particular for ripening hard or semi-hard cheese, preferably rind cheese. This method, thanks to the peculiar transmission properties of the film, provides cheese more similar to naturally ripened cheese, with a minor loss of water, due to evaporation, with reduced mold and yeast growth, and without significant flavor, consistency and color deviations.

The present invention relates to a method, film and package for cheese ripening and preservation, in particular for ripening and preservation of hard or semi-hard cheese, preferably rind cheese.

### BACKGROUND ART

Conventional processes for the ripening of hard to semi-hard cheeses are known. The most traditional way, known as ‘natural ripening’, involves air-drying cheese and often applying a coating to protect them from external factors at the end of ripening. A major advantage of the natural ripening process, is that cheese can be obtained with different ripening degrees, ranging from young cheese to old cheese. Another major advantage is that the natural ripening process results in cheese having a flavor that is usually appreciated as very good.

Further characteristics typical for a natural ripened cheese are firmness, low stickiness, color deviation from the center of the cheese towards the surface and the presence of a drying rind.

A disadvantage of the natural ripening process is the relatively high loss of water out of the cheese. Under practical conditions (RH=85% and T=12-14° C.), 10-12% of the cheese weight can be lost in 10-12 weeks of ripening due to the evaporation of water out of the cheese. Furthermore, under these storage conditions, an excess of mold growth may occur which then frequently results in serious adverse effects; in fact, sometimes mold growth is so excessive that the cheese cannot be sold for consumption.

To minimize mold growth, cheese surface may be washed during and after ripening with different cleaning agents and, in addition coated with coatings containing mold inhibitors like natamycin.

Another process, used to obtain young cheese, involves packing the cheese in a seal-tight film straight after brining (foil ripening).

Foil ripening comprises packaging and storing cheese in foils, at controlled atmosphere, temperature and humidity conditions. Depending on the foil transmission properties, this process may be associated with several drawbacks such as scarce or bad flavor, low firmness and stickiness, development of molds and loss of shape of the ripened cheese. A foil-packed cheese may have a typical flat taste, be excessively soft and rindless.

The documents WO2009047332A2, EP2335489A2 and EP2460414A2 provide an overview of the state of the art of cheese-ripening and of the most common technical problems experienced with foil ripening.

WO2009047332A2 in the name of DSM discloses a method for cheese-aging in which shrinkable films, characterized by a WVTR (water vapor transmission rate) of at least 10 g/m²·day and by an OTR (oxygen transmission rate) of at most 100 cc/m²·day·atm (measured at 10° C. and 85% RH) are used. These films are made of conventional non-biodegradable high barrier resins such as polyamides, polyetheresters and/or polyetheramides.

EP2335489A2 in the name of CSK describes methods for foil cheese ripening under individual ripening conditions. This method claims to use foils characterized inter alia, by OTR higher than 100 and lower than 1000, preferably between 120 and 900 (claim 2) cc/m²·day·atm (at 12° C. and 85% RH). However, this document only exemplifies foils having OTR from 665 to 1000 cc/m²·day·atm or not higher than 182 (see Table 2 and Example 4).

EP2460414A2 in the name of CSK discloses a method for foil-ripening cheese using foils having a WVTR (water vapor transmission rate) of at least 1 g/m²·day at 12° C. and 85% RH, an OTR (oxygen transmission rate) lower than 1000 cc/m²·day·atm at 12° C. and 85% RH and a tensile modulus of 150-400 MPa at 12° C. and 85% RH. Typical ripening foil are multi-layered foils wherein one or more layers (e.g. the layer in contact with the cheese and/or an outer layer) comprise a statistical, aliphatic-aromatic co-polyester, in particular a statistical, aliphatic-aromatic co-polyester of the monomers 1,4-butanediol, adipic acid, and a terephthalic acid. The layer of the multi-layer foil in contact with the cheese and/or the outer layer may additionally or alternatively comprise a polyester urethane copolymer.

There is still the need for a method for ripening cheese, especially rind, semi-hard and hard cheese, which provides for improved organoleptic properties and appearance more similar to natural ripened cheese, which keeps the shape of the product, prevents weight loss and suppress molds formation. Most desirably, said method uses biodegradable films.

### SUMMARY OF THE INVENTION

It is thus a first object of the present invention a biodegradable film for cheese ripening or preservation characterized by
an OTR (Oxygen Transmission Rate) from 200 to 450 cc/m²·day·atm, (measured at 12° C., 95% in-85% out of relative humidity RH according to ASTM F1927),
a MVTR (Moisture Vapor Transmission Rate) from 500 to 900 g/m²·day·atm, (measured at 38° C., 98% in-0% out % of relative humidity RH according to ASTM F1249),
a CTR (Carbon dioxide Transmission Rate) from 2000 to 6000 cc/m²·day·atm (measured at 23° C., 0% in-0% out of relative humidity RH according to ASTM F2476) and, optionally,
a free shrink percentage in at least one of LD and TD directions of at least 20% (measured at 85° C. in water according to ASTM D2732).

It is a second object of the present invention a flexible optionally heat-shrinkable container for cheese ripening or preservation made of a film according to the first object.

It is a third object of the present invention a package for cheese ripening or preservation comprising a film according to the first object and enclosing a cheese.

It is a fourth object of the present invention a method for cheese ripening and/or preservation which comprises

(i) providing a cheese
(ii) introducing the cheese into a flexible, container comprising a biodegradable optionally heat-shrinkable film and containing an opening for receiving the cheese, or
packaging the cheese in a biodegradable optionally heat-shrinkable film according to a form-fill-seal packaging process,
(iii) closing, preferably under vacuum, and optionally shrinking the package around the cheese, and
(iv) ripening and/or preserving the packaged cheese,
wherein said biodegradable optionally heat-shrinkable film is a film according to the first object of the invention.

It is a fifth object of the present invention a ripened cheese obtainable according to the method of the fourth object.

It is a sixth object of the present invention the use of the biodegradable film according to the first object, or of the flexible container according to the second object, for ripening or preserving cheese.

### Definitions

As used herein, the term “film” is inclusive of plastic web, regardless of whether it is film or sheet or tubing.

As used herein, the terms “inner layer” and “internal layer” refer to any film layer having both of its principal surfaces directly adhered to another layer of the film.

As used herein, the phrase “outer layer” or “external layer” refers to any film layer having only one of its principal surfaces directly adhered to another layer of the film.

As used herein, the phrases “seal layer”, “sealing layer”, “heat seal layer”, and “sealant layer”, refer to an outer layer involved in the sealing of the film to itself, in particular to the same outer seal layer or to the other outer layer of the same film, to another film, and/or to another article which is not a film.

As used herein, the words “tie layer” or “adhesive layer” refer to any inner film layer having the primary purpose of adhering two layers to each other.

As used herein, the phrases “longitudinal direction” and “machine direction”, herein abbreviated “LD” or “MD”, refer to a direction “along the length” of the film, i.e., in the direction of the film as the film is formed during coextrusion.

As used herein, the phrase “transverse direction” or “crosswise direction”, herein abbreviated “TD”, refers to a direction across the film, perpendicular to the machine or longitudinal direction.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is generally fed into a rotating screw of variable pitch, i.e., an extruder, which forces the polymeric material through the die.

As used herein, the term “coextrusion” refers to the process of extruding two or more materials through a single die with two or more orifices arranged so that the extrudates merge and weld together into a laminar structure before chilling, i.e., quenching. The term “coextrusion” as used herein also includes “extrusion coating”.

As used herein, the term “extrusion coating” refers to processes by which a “coating” of molten polymer(s), comprising one or more layers, is extruded onto a solid “substrate” in order to coat the substrate with the molten polymer coating to bond the substrate and the coating together, thus obtaining a complete film.

As used herein the terms “coextrusion”, “coextruded”, “extrusion coating” and the like are referred to processes and multilayer films which are not obtained by sole lamination, namely by gluing or welding together pre-formed webs.

As used herein, the term “orientation” refers to “solid state orientation” namely to the process of stretching of the cast film carried out at a temperature higher than the Tg (glass transition temperatures) of all the resins making up the layers of the structure and lower than the temperature at which all the layers of the structure are in the molten state. The solid state orientation may be mono-axial, transverse or, preferably, longitudinal, or, preferably, bi-axial.

As used herein, the phrases “orientation ratio” and “stretching ratio” refer to the multiplication product of the extent to which the plastic film material is expanded in the two directions perpendicular to one another, i.e. the machine direction and the transverse direction. Thus, if a film has been oriented to three times its original size in the longitudinal direction (3:1) and three times its original size in the transverse direction (3:1), then the overall film has an orientation ratio of 3×3 or 9:1.

As used herein the phrases “heat-shrinkable,” “heat-shrink,” and the like, refer to the tendency of the solid-state oriented film to shrink upon the application of heat, i.e., to contract upon being heated, such that the size of the film decreases while the film is in an unrestrained state.

As used herein said term refers to solid-state oriented films with a free shrink in at least one of machine and transverse directions, as measured by ASTM D 2732, of at least 20% at 85° C.

As used herein the phrases “total free shrink” means a value determined by adding the percent free shrink in the machine (longitudinal) direction to the percentage of free shrink in the transverse (crosswise) direction. The total free shrink is expressed as percentage (%).

As used herein, the term “polymer” refers to the product of a polymerization reaction, and is inclusive of homo-polymers, and co-polymers.

As used herein, the term “homo-polymer” is used with reference to a polymer resulting from the polymerization of a single type of monomer, i.e., a polymer consisting essentially of a single type of mer, i.e., repeating unit.

As used herein, the term “co-polymer” refers to polymers formed by the polymerization reaction of at least two different types of monomers. For example, the term “co-polymer” includes the co-polymerization reaction product of ethylene and an alpha-olefin, such as 1-hexene. When used in generic terms the term “co-polymer” is also inclusive of, for example, ter-polymers. The term “co-polymer” is also inclusive of random co-polymers, block co-polymers, and graft co-polymers.

As used herein, the term “polyester” refers to homopolymers or copolymers (also known as “copolyesters”) having an ester linkage between monomer units which may be formed, for example, by condensation polymerization reactions of lactones or by polymerization of dicarboxylic acid(s) and glycol(s). With the term “(co)polyesters” both homo and copolymers are intended.

As used herein, the term “aromatic polyester” refers to homopolymers or copolymers (also known as “copolyesters”) having an ester linkage between one or more aromatic or alkylsubstituted aromatic dicarboxylc acids and one or more glycols. The term “(co)polyesters” refer to both homo- and copolymers.

As used herein, the term “adhered” is inclusive of films which are directly adhered to one another using a heat-seal or other means, as well as films which are adhered to one another using an adhesive which is between the two films.

As used herein, the phrase “directly adhered”, as applied to layers, is defined as adhesion of the subject layer to the object layer, without a tie layer, adhesive, or other layer therebetween.

In contrast, as used herein, the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

As used herein, the acronym “OTR” means Oxygen Transmission Rate.

As used herein, the acronym “WVTR” means Water Vapor Transmission rate.

As used herein, the acronym “MVTR” means Moisture Vapor Transmission Rate

As used herein, the acronym “CTR” means Carbon dioxide Transmission Rate.

As used herein, the acronym “RH” means relative humidity.

As used herein, the term “biodegradable” refers to films, polymers or products that have the ability to break down, safely and relatively quickly, by biological means, into the raw materials of nature and disappear into the environment. These products can be solids biodegrading into the soil (which we also refer to as compostable), or liquids biodegrading into water. Biodegradable plastic is intended to break up when exposed to microorganisms.

As used herein, the phrase “flexible container” is inclusive of end-seal bags, which have an open top, seamless (i.e., folded, unsealed) side edges, and a seal across the bottom of the bag, transverse-seal bags, which have an open top, a seamless bottom edge and each of the side edges with a seal therealong, and L-sealed bags, which have an open top, a sealed bottom, one transverse-seal along a first side edge and a seamless second side edge, and seamless casings.

As used herein, the phrase “a seamless tube or casing” relates to a tube devoid of any seal, which is generally made of a film (co)extruded through a round die.

As used herein, the term “package” is inclusive of packages made from containers or tubes, by placing a product in the article and sealing the article so that the product is substantially surrounded by the heat-shrinkable film from which the packaging container is made.

As used herein, the term “bag” refers to a packaging container having an open top, side edges, and a bottom edge. The term “bag” encompasses lay-flat bags, pouches, casings (seamless casings and backseamed casings, including lap-sealed casings, fin-sealed casings, and butt-sealed backseamed casings having backseaming tape thereon). Various casing configurations are disclosed in U.S. Pat. No. 6,764,729 and various bag configurations, including L-seal bags, backseamed bags, and U-seal bags (also referred to as pouches), are disclosed in U.S. Pat. No. 6,790,468 Unless otherwise stated, all the percentages are percentages by weight.

### DETAILED DESCRIPTION OF THE INVENTION

The biodegradable, optionally heat-shrinkable, film for cheese ripening or cheese preservation of the present invention is a monolithic film, namely it is a film not containing holes, perforations, pores or micro-pores that provide a direct pathway for water molecules to flow. A monolithic film is able to transport water molecules by molecular diffusion through the polymer matrix.

The film of the present invention is a biodegradable film, consisting of at least 30%, 40%, 50%, 60%, 70%, 80%, 90%, 95%, 99% or of 100% by weight of biodegradable polymers.

Biodegradable polymers are selected from the group of polysaccharides, (co)polyesters and their blends.

Examples of suitable polysaccharides are starches, preferably potato starches and their derivatives.

Examples of suitable biodegradable polyesters are polycaprolactone (PCL), polyhydroxybutyrate, polylactic acid esters or copolyesters of 1,4 butanediol, adipic acid and terephthalic acid, in particular is statistical, aliphatic-aromatic co-polyester of the monomers 1,4-butanediol, adipic acid, and a terephthalic acid named Ecoflex, or those described in EP1074570.

Further suitable biodegradable polymers may be polyester amides, such as for instance those described in WO9621692.

Particularly preferred biodegradable polymers are polycaprolactone, a coPET (copolyester of 1,4 butanediol, adipic acid and terephthalic acid) named Ecoflex F Blend C1200 (Basf), a starch-based polymer named BioPar® (Biopolymer Technologies) and the potato starch derivative Bioplast GF 106/02 (Biotec). The film of the present invention is a monolayer or multilayer film, preferably a multilayer film.

In case of a monolayer film, the biodegradable polymer may comprise for instance Bioplast GF106 (Biotec).

Preferably, the present film includes at least two layer NB.

Preferably the present film includes three layers A/B/A in which A may be the same or different, preferably the same.

Preferably the present film consists of three layers A/B/A in which A may be the same or different, preferably the same.

In the multilayer films, preferably layer B is the bulk layer, namely the layer that amount at least to 60%, 70%, 80%, 85%, 90% in respect of the total film thickness. In case of three layers films, the outer layers A preferably have the same thickness.

Preferably layer(s) A comprises, more preferably is made of a biodegradable polymers such as for instance Ecoflex, Polycaprolactone, Ecovio® (BASF), MaterBi® (Novamont), preferably of Ecoflex.

Preferably layer B comprises, more preferably is made of a starch, preferably a potato starch derivative.

Preferably layer B comprises, more preferably is made of, a starch, preferably a natural potato starch and derivatives thereof.

In one embodiment, layer B is made of potato starch and, optionally, derivatives not blended with plasticizers.

Preferably, layer B does not include thermoplastic starch (TPS) or includes less than 20%, 10%, 5%, 2% by weight with respect to the layer weight.

As used herein the term “thermoplastic starch” refers to a native starch or a starch derivative that has been rendered destructured and thermoplastic by treatment with one or more plasticizers, with at least one plasticizer still remaining. Thermoplastic starch compositions are well known and disclosed in several patents, for example: U.S. Pat. Nos. 5,280,055; 5,314,934; 5,362,777; 5,844,023; 6,214,907; 6,242,102; 6,096,809; 6,218,321; 6,235,815; 6,235,816; and 6,231,970.

Preferably, the present film comprises at least 80% or at least 85% by weight of a starch in respect of the total weight of the film.

In one embodiment, layer B is made of Bioplast GF106 (Biotec).

More preferably, the present film is a three layers film A/B/A in which layer A is made of a biodegradable copolyester and layer B is made of a starch, preferably potato starch.

Most preferably, the present film is a three layers film A/B/A in which layer A is made of a biodegradable copolyester and layer B is made of a potato starch not blended with plasticizers.

In one embodiment, layer B is made of potato starch—and optionally derivatives thereof—blended with plasticizers.

Preferably, the outer layers A have about the same thickness, which provides films with minimal or no curling.

Preferably, the biodegradable polymer of layer(s) A is chosen among heat sealable biodegradable polymers, preferably characterized by one or more of the following properties: a melting temperature from 110 to 120° C., a melt flow rate (MFR) from 2.7 to 4.9 g/10 min (measured at 190° C., 2,16 Kg), a VICAT softening point of about 91° C., a density from 1.25 to 1.27 g/cc.

One or more of the layers of the film of the present invention may contain any of the additives conventionally employed in the manufacture of polymeric films. Thus, agents such as pigments, lubricants, anti-oxidants, radical scavengers, UV absorbers, thermal stabilizers, anti-blocking agents, surface-active agents, slip aids, optical brighteners, gloss improvers, viscosity modifiers may be incorporated as appropriate.

Preferably, slip and/or anti-blocking additives may be added to one or more of the layers of the film, more preferably to one or both of the outer layers. For example, in an NB layer, these additives may be added to layer A, or to layer B or to both layer A and layer B. In an A/B/A layer, these additives may preferably be added to one or both of the outer layers A. The presence of slip and/or anti-blocking additives allows to improve the processing of the film in a high speed packaging equipment. These additives may be added in the form of a concentrate in a carrier resin (masterbatch). The amount of carrier is typically in the order of 2-4% of the total weight of the layer. An exemplary masterbatch which can be used in the invention is available from PolyOne Corp. and sold under the trade name ABSL BIO E 0138.

The total thickness of the present film is generally from 150 to 20 microns, preferably from 100 to 50 microns.

The film of the present invention is a coextruded film.

The skilled in the art is able to select biodegradable polymers and their blends as components of monolayer or bi or three or more layers film, provided that the final transmission properties complies with the values previously stated.

The present film differs from prior art films at least for the specific OTR values.

In particular, the film according to present invention is preferably characterized by
an OTR from 220 to 360, from 240 to 340, preferably from 260 to 320, more preferably from 280 to 300 cc/m²·day·atm, (measured at 12° C., 95% in-85% out RH according to ASTM F1927),
a MVTR from 500 to 700, preferably 550 to 630 or 570 to 610 g/m²·day·atm, (measured at 38° C., 98% in-0% out RH according to ASTM F1249),
a CTR from 3000 to 6000, preferably from 4000 to 6000 or from 4500 to 5500 cc/m²·day·atm (measured at 23° C., 0% in-0% out RH according to ASTM F2476) and, optionally
a free shrink percentage in at least one of the longitudinal LD and transverse TD directions of at least 25% (measured at 85° C. in water according to ASTM D2732). Preferably the present film is also characterized by a WVTR (Water Vapor Transmission Rate) from 10 to 150, from 10 to 50, from 10 to 40, from 15 to 30, from 15 to 25 g/m²·day·atm, said WVTR being measured at 10° C., 100% in-85% out RH according to ASTM E96/E96M-15 water method.

The peculiar selection and combination of these features provide for an ideal method for ripening or preserving cheese, especially rind cheese.

Preferably the film of the invention, has a WVTR lower than 60, than 50, than 40, than 30 g/m²·day·atm. Advantageously, the water vapor permeability of the present film avoids that the surface of the cheese dehydrates excessively, resulting in a thick dehydrated surface (dry-rind). The dehydrated surface layer will reduce further water loss during ripening or preservation of the cheese.

In one preferred embodiment, the film according to present invention is characterized by
an OTR from, from 240 to 340 cc/m²·day·atm, (measured at 12° C., 95% in-85% out RH according to ASTM F1927),
a MVTR (Moisture Vapor Transmission Rate) from 550 to 630 g/m²·day·atm, (measured at 38° C., 98% in-0% out RH according to ASTM F1249),
a CTR from 4000 to 6000 cc/m²·day·atm (measured at 23° C., 0% in-0% out RH according to ASTM F2476) and, optionally
a free shrink percentage in at least one of LD and TD of at least 25% (at 85° C. in water according to ASTM D2732).

In a preferred embodiment the film of the present invention is characterized by
an OTR from 260 to 320, preferably from 260 to 320, more preferably from 280 to 300 cc/m²·day·atm, (measured at 12° C., 95% in-85% out RH according to ASTM F1927),
a MVTR from 500 to 700, preferably 550 to 630 or 570 to 610 g/m²·day·atm, (measured at 38° C., 98% in-0% out RH according to ASTM F1249),
a CTR from 3000 to 6000, preferably from 4000 to 6000 or from 4500 to 5500 cc/m²·day·atm (measured at 23° C., 0% in-0% out RH according to ASTM F2476) and, optionally
a free shrink percentage in at least one of the longitudinal LD and transverse TD directions of at least 20% (measured at 85° C. in water according to ASTM D2732). In a preferred embodiment, the film of the present invention is a biodegradable, three layer film A/B/A consisting of
   two outer layers A made of a copolyester and
   a bulk core layer B made of a potato starch,
      characterized by an OTR from 220 to 360, more preferably from 210 to 350 cc/m²·day·atm (measured at 12° C., 95% in-85% out RH according to ASTM F1927), a MVTR from 500 to 900 g/m²·day·atm, (measured at 38° C., 98% in-0% out % RH according to ASTM F1249 and a CTR from 2000 to 6000, preferably from 3000 to 6000 cc/m²·day·atm (measured at 23° C., 0% in-0% out RH according to ASTM F2476).

The film of the present invention is preferably a heat-shrinkable film.

Preferably, the film of the invention is heat-shrinkable in both LD and TD directions.

Preferably, the film of the invention has a total free shrink (sum of free shrink percentage in LD and TD) of at least 20%, 30%, 40%, 50%, 60% or 70%.

The films of the present invention are characterized by good mechanical properties.

The film of the present invention preferably has an elastic modulus from 2000 to 4000 Kg/cm² or from 2000 to 3000 Kg/cm² in at least one of, preferably in both, the LD and TD directions.

The film of the present invention preferably has a tensile strength from 400 to 700 Kg/cm² or from 400 to 600 Kg/cm², in at least one of, preferably in both, the LD and TD directions.

The film of the present invention preferably has an elongation at break from 200 to 350% or from 200 to 300%, in at least one of, preferably in both, the LD and TD directions.

The film of the present invention preferably has a gloss at 60° of at least 75 GU, preferably of at least 80 GU.

Most preferably, the film of the present invention is a biodegradable heat shrinkable three layers film consisting of two outer layers, made of a biodegradable copolyester named Ecoflex F Blend C1200 supplied by BASF and of a core bulk layer, made of a potato starch derivative named Bioplast GF 106/02 supplied by Biotec.

Preferably, in case of three layers structures, the total amount of copolyesters, preferably the total amount of Ecoflex is lower than 20%, preferably lower than 15% by weight, with respect to the entire film weight.

Usually, the film according to the present invention is produced from the melt by known techniques, such as for example cast-extrusion or extrusion-blowing.

Preferably, the film according to the present invention is manufactured by coextrusion with a round die followed by orientation.

Coextrusion, due to the possible thermolability of certain biodegradable resins is, preferably performed at controlled temperatures, more preferably at temperatures not higher than 190° C., preferably not higher than 180° C.

Orientation may be monoaxial but preferably is a biaxial orientation.

Preferably, biaxial orientation is simultaneous, in both LD and TD.

Most preferably, the present film is manufactured by coextrusion followed by trapped bubble orientation.

The tube is heated to a temperature which is above the Tg of all the resins employed and below the melting temperature of at least one of the resins employed, typically by passing it through a hot water bath, or alternatively by passing it through an IR oven or a hot air tunnel, and expanded, still at this temperature by internal air pressure to get the transverse orientation and by a differential speed of the pinch rolls which hold the thus obtained “trapped bubble”, to provide the longitudinal orientation.

The heating temperature of the tube or of the tape ranges from 70 to 98° C. depending on several factors such as the nature and amount of each resin within the tube, the thickness of the tube, the orientation ratios to be achieved as known to the skilled in the art.

Typical orientation ratios for the films of the present invention can be comprised between 2:1 and 6:1 preferably between 3:1 and 5:1 in each direction, even more preferably between 2:1 and 3.5:1 in each one of the longitudinal and transverse direction.

Preferably, the orientation temperature is from 80° C. to 98° C.

Preferably heating of the intermediate tube is performed by passing through hot water bath. Preferably, to prevent any unwanted hydrolysis of the biodegradable resins, residence time in the water bath is lower than 5 sec, more preferably lower than 2 sec.

Orientation ratio is preferably not higher than 3.2:1, more preferably not higher than 3.0:1 in both LD and TD directions.

After having been stretched, the film is quickly cooled, preferably in cold air, at temperature between 4 and 30° C., preferably between 5 and 10° C., while substantially retaining its stretched dimensions to somehow freeze the molecules of the film in their oriented state and rolled.

If desired, the film may be cross-linked, either chemically or, preferably, by irradiation. Typically, to produce cross-linking, an extrudate is treated with a suitable radiation dosage of high energy electrons, preferably using an electron accelerator, with the dosage level being determined by standard dosimetry methods. A suitable radiation dosage of high-energy electrons is in the range of up to about 120 kGy, more preferably about 16-80 kGy, and still more preferably about 34-64 kGy. Other accelerators such as a Van der Graff generator or resonating transformer may be used.

The radiation is not limited to electrons from an accelerator since any ionizing radiation may be used.

Irradiation is preferably performed prior to orientation, and it is carried out either on the overall co-extruded or extrusion-coated tape. Irradiation could however be performed also after orientation.

Preferably, the films of the present invention are not cross-linked, either chemically or by irradiation.

Alternatively, mono- or bi-axially oriented heat-shrinkable films can be obtained by extruding the polymers through a flat die in the form of a sheet, and after a quenching step, heating the sheet to the orientation temperature and stretching it. Longitudinal orientation is generally obtained by running the sheet over at least two series of pull rolls wherein the second set runs at a higher speed than the first one. Cross-wise or transversal orientation is generally done in a tenter frame where the edges of the sheet are grasped by clips carried by two continuous chains running on two tracks that move wider apart as they go along. When bi-axially oriented films are desired, as an alternative to sequential stretching, i.e. either longitudinal first and then transversal or vice-versa, the stretching may be simultaneous in both directions. The stretched film is then cooled and rolled up as usual.

Also in the case of orientation by a tenter frame, the stretch is usually at least about 3 times in each one of LD and TD directions, but higher ratios are also common.

The present films are converted into flexible containers such as bags and pouches, in which cheese is introduced and, preferably after vacuumization, optionally shrinking and sealing, let ripen therein.

It is a second object of the present invention a flexible, optionally heat-shrinkable, container for cheese-ripening or preservation made of a film according to the first object.

The flexible container may be manufactured by self-sealing the film according to the present invention. The self-sealing of the film according to the present invention can be accomplished in a fin seal and/or lap seal mode.

The flexible container according to the invention may be a bag, such as an end-seal bag (ES), a side (or transverse TS) seal bag, or a pouch. Typically, these flexible containers are made before being filled (pre-made).

In particular, the flexible container may be an ES bag (end-seal bag), obtainable from a flattened tubing of thermoplastic material by transversely sealing and by severing the bottom end of the bag, or a TS bag (transverse seal bag), typically obtained by folding longitudinally a flat film and sealing and severing it transversely. In both the ES and TS bags currently available on the market, the seals are fin seals i.e. seals where one surface of the packaging film is always sealed to itself.

Preferably, the present bags are heat-shrinkable.

Flexible containers according to the present invention may also be made as they are filled by using horizontal form fill machines. Such packages are made from a film according to the present invention, shaped into a tube by a longitudinal seal while at the same time the article to be packed is inserted into this tube. Thereafter the tube is closed at its two ends by two hermetic transverse heat seals. The closed bags are vacuumized prior to, possibly, heat shrinking.

These HFFS systems and processes are per se conventional and well known in the art.

It is a third object of the present invention a package for cheese ripening or preservation comprising a film according to the first object and enclosing a cheese The present package is preferably vacuumized, generally at pressures comprised between 0.5 and 1000 mbar, preferably for hard to semi-hard cheese from 5 to 25 mbar and for sensitive cheese from 600 to 800 mbar (soft vacuum).

Preferably the present cheese package is shrunk, thus reducing the residual air and possible contaminations deriving therefrom.

In one embodiment, the present package is vacuumized.

In one embodiment, the present package is vacuumized and shrunk.

The outer surface of the package may be printed for example for branding purposes, as known in the art.

The package according to the invention may include, in addition to the cheese product, other packaging articles such as parchments, palure or paper articles, traditionally used in cheese packaging, which are kept enclosed in the package of the invention.

It is a fourth object of the present invention a method for cheese ripening and/or preservation.

The Applicant has found that the film of the present invention provides for optimal conditions both for ripening unripened or partially ripened cheese and for preserving ripened cheese with an unexpected an extension of shelf-life.

In one embodiment, the method only includes cheese ripening,

In one embodiment, the method only includes cheese preservation.

In one embodiment, the method includes cheese ripening followed by preservation.

The environmental conditions of the present ripening or preservation method may differ, typically ranging from 20 to 95% of RH and from 1 to 25° C.

In the present method of ripening, cheese after brining and, possibly, after a period of natural ripening, are typically packaged in bags, preferably under vacuum.

The packages are preferably stored at temperatures from 10 to 20° C. and at environmental Relative Humidity of 75-95% in a cell for maturation up to, for instance, 120 days or when the product is ready to be commercialized (i.e. when the product reaches a typical percentage of dry matter, taste, color etc. . . . ) Preferably, at least one brining pre-treatment of the cheese is performed before the present ripening method. The brining step may be performed as known in the art.

In the method of ripening of the present invention, at least a part of the ripening is performed while the cheese is present in the cheese-ripening package.

In one embodiment, the entire ripening process is effected while the cheese is present in the cheese-aging package.

In the present method, the cheese-ripening package may be closed by clipping or sealing, preferably by sealing, most preferably by heat sealing.

In the present method, cheese milk can be used to which, in addition to the customary amount of acid, one or more starters are optionally added, to improve and speed-up the ripening process as known in the art or as described for example in EP1287744A1.

In the present method, the package tightly covers the surface of the cheese to be ripened in order to prevent residual air remaining in the package, which is disadvantageous for formation of molds and inadequate presence of moisture and, in the end, for non-homogeneous ripening over the entire cheese.

Accordingly, the package is preferably vacuumized and, optionally, heat shrunk prior to closing, as commonly known in the art of packaging.

Generally, the package is vacuumized at pressures comprised between 0.5 and 1000 mbar, preferably for hard to semi-hard cheese from 5 to 25 mbar and for sensitive cheese from 600 to 800 mbar (soft vacuum).

Furthermore, the present packages are optionally heat-shrunk, preferably by submersion in hot water baths, preferably at temperatures not higher than 90° C. and for times no longer than 5 sec.

As an alternative, hot air shrinking may be applied, for instance by hot air heating at 140-160° C. for 5 seconds.

In a preferred variant of the present method, the package is vacuumized and shrunk. The method of the present invention may further comprises treating the cheese after brining with a composition comprising an antimicrobial compound such as for instance natamycine and/or nisine prior to introducing the cheese into the cheese-ripening package.

Preferably, the method of the present invention does not include an antimicrobial treatment.

In one embodiment of the method of the invention, the cheese-aging container is a pre-made bag. In this embodiment, the method comprises introducing cheese to be ripened into a bag or pouch and closing the bag by, preferably hermetically sealing the opening for receiving the cheese to be ripened.

The pre-made bag may be produced from flat film and contain at least one seal or alternatively, the bag may be produced from a tubular film resulting in a seamless tubular casing.

In another embodiment of the method of the invention, the cheese is packaged according to a form-fill-seal process, as known in the art, with a film according to the invention.

The ripening method of the invention comprises ripening the packaged cheese, preferably, by storing the packaged cheese to be ripened in such a conditions that moisture can leave the foil packaged cheese.

A controlled water evaporation may be obtained for instance by leaving enough room between stored foil packaged cheeses and/or by regulating the relative humidity and temperature of the environment.

The foil-packaged cheese is preferably ripened under certain conditions of relative humidity and temperature.

In the present ripening method, the environmental relative humidity preferably ranges between 75 and 90%. During ripening, the temperature preferably ranges between 10 and 20° C.

The environment conditions together with the water vapor transmission rate of the cheese-ripening film are preferably chosen such that during ripening the total amount of moisture which is allowed evaporate from the foil-packaged cheese is from 0.5 to 20%, preferably lower than 15%, than 10% or than 5% by weight.

The ripening time may be in the range of about 20 days or longer, and in general equal to or less than about 2 years, preferably equal to or less than about 1 year, such as for instance of about 3 months or less, depending on the cheese.

Preferably, for hard or semi-hard cheese, the ripening method may be effected at temperatures such as for instance from 4 to 14° C., preferably from 10 to 14° C. or 12 to 14° C. and at a relative humidity of the environment of 75%-85%.

In the present method, the cheese to be ripened is preferably a hard or semi-hard cheese or a rind cheese such as for instance a Pecorino, Taleggio, Cascaval, Manchego, Raclette, Rigatino, Gouda, Emmental, Edam, Tilsit, Gruyere, Cheddar and Maasdam.

In the present method, the cheese may be an unripened, a partially ripened or a ripened cheese.

In case of a ripened cheese, it may be packaged and preserved according to the preservation method of present invention.

The Applicant has found that the properties of the present film provides for an optimal preservation of ripened cheese during storage and transportation.

Typically, storage and transportation are effected under environmental conditions generally different from those applied during ripening, preferably at environmental Relative Humidity from 50 to 70% and/or temperatures from 1 to 6° C.).

Advantageously, the present method of preservation maintains the good consistency, flavor and taste of the product and meanwhile prevents undesired fermentations and mold growth.

The Applicant has found that, for washed-rind, smear ripened cheese, such as Taleggio, the present method allows an unexpected extension of shelf life.

In particular, packages according to the invention comprising ripened Taleggio stored at 1-6° C., at 50% R.H., have increased the conventional shelf-life of Taleggio from 75 to 100 days.

Accordingly, a preferred method according to the fourth object is a method of cheese preservation further characterized by the following features:

i) cheese is a washed-rind smear ripened cheese, preferably Taleggio;
ii) cheese is wrapped into a paper wrapping before being introduced into the flexible container, and
iii) closing of the container is performed under vacuum.

Preferably, in a preferred method of preservation, the paper wrapping includes at least a pelure, placed in contact with the cheese, and an external wrapping paper.

As used herein the term “pelure” refers to a type of paper used for the labels of cheese, which may show the name of the brand and other information about the product (aging, composition etc.). The pelure generally prevents undesirable adhesions between the external wrapping paper and the cheese surface, which upon opening of the package, may damage the product.

In the natural ripening process (i.e. without any foil) traditionally cheese needs to be salted several times (e.g. by dipping in salt water, operation known as brining, and/or by dry salting) in order to prevent mold formation and to allow proper development of cheese flavor.

The present packages, due to medium permeability to oxygen, high permeability to water and carbon dioxide and preferably tightness—thanks to vacuumization and shrinking, which minimize the presence of residual air—provide for drier surfaces and prevent mold formation. Accordingly, the present method can possibly reduce the number of salting steps and even avoid antimicrobial treatments. Furthermore, the present packages efficaciously prevent water loss and give higher process yields.

Despite the difference in water loss and salt content, no alternation of the taste of the product was observed with respect to a natural ripened cheese.

In a preferred embodiment of the present method, the cheeses are individually ripened and are not in contact with other cheeses. It is especially preferred that ripening is realized under conditions wherein each cheese is individually placed on (wooden) shelves and wherein there is essentially no contact between the cheeses (individual ripening).

Under these conditions, the shape of the cheese is maintained thanks to the preferably vacuumized packaging and, possibly, to the force exerted by the shrunk film. The tight adhesion of the film to the cheese also prevents mold growth.

After the foil-packaged cheese has been ripened for a desired time, the cheese-ripening film is removed.

After ripening, the cheese preferably comprises an outer rind and an interior cheese mass, wherein the color of the outer rind is darker than the color of the interior cheese mass. This phenomenon, commonly associated with natural ripened cheeses, is known to the skilled person as a “drying rind”.

In conclusion, the method of the present invention, show several advantages with respect to known foil ripening processes for instance it provides a cheese which is more similar to naturally ripened cheese, with a minor loss of water due to evaporation, without significant flavor, consistency, color deviations and mold and yeast growth. Furthermore, the present method of ripening does not required a too strict control of the environmental conditions.

Finally, the present method may be applied to preserve ripened cheese, in particular washed-rind, smear ripened cheese.

It is a fifth object of the present invention a ripened cheese obtainable according to the method of the fourth object.

The ripened cheese according to the invention is characterized in that:
it does not contain any plastic coating on the surface of the ripened cheese
preferably, it does not contain antimicrobial compounds.

It is a sixth object of the present invention the use of the biodegradable film described herein, according to the first object of the invention, or the use of the flexible, optionally heat-shrinkable container according to the second object of the invention, for ripening or preserving cheese.

Preferably, according to this object, a flexible container manufactured by sealing the biodegradable film of the invention to itself can be used. More preferably, a bag, such as an end-seal bag (ES), a side (or transverse, TS) seal bag, or a pouch can be used as the container.

In a preferred embodiment, the biodegradable film or the flexible, optionally heat-shrinkable container can be used to ripen or preserve a cheese selected among Pecorino, Taleggio, Cascaval, Manchego, Raclette, Rigatino, Gouda, Edam, Tilsit, Gruyere, Cheddar, Emmental and Maasdam.

### EXAMPLES

The following Examples provide illustrative embodiments of the present invention. Those of ordinary skill in the art will appreciate that the following Examples are intended to be exemplary and that numerous changes, modifications, and alterations can be employed without departing from the scope of the presently disclosed subject matter.

### Packaging Material: Resins and Structures

The following resins were used in the manufacture of the film of the invention:

TABLE 1

| Trade name | Supplier | Acronym | Chemical nature |
|---|---|---|---|
| Ecoflex F | BASF | PET | Biodegradable PET (copolyester |
| Blend C1200 | | | of 1,4 butanediol, adipic acid |
| | | | and terephthalic acid) |
| Bioplast GF | Biotec | STAR | Biodegradable potato starch |
| 106/02 | | | derivative, native, not blended |
| | | | with plasticizer |

in which
PET: Ecoflex F Blend C1200 is a biodegradable copolyester, having a Density 1.26 g/cc, Melt Flow Rate (190° C./02.16 kg) of 3.8 g/10 min, Melting point 115° C., Vicat softening point 91° C. (method VST A/50, ISO 306:2004);
STAR: Bioplast GF 106/02 is a biodegradable starch derivative, supplied by Biotec, having a Density 1.25 g/cc, Melt Flow Rate (190° C./02.16 kg) 0.69 g/10 min, Vicat softening point 65° C..

### Example 1

The film for the method of the invention had the following structure:

TABLE 2

| | | Final | Tube | |
|---|---|---|---|---|
| Ex. 1 | | thickness | thickness | Thickness |
| Layers | Resins | (microns) | (microns) | ratio % |
| 1 | PET | 4.8 | 30 | 6.9 |
| 2 | STAR | 60.5 | 380 | 86.2 |
| 3 | PET | 4.8 | 30 | 6.9 |
| Tot. | | 70.1 | 440 | 100 |

Total content of PET is 13.7% while of STAR is 86.3% by weight.

### Manufacturing of the Film

The film was prepared by co-extrusion with a round cast plate die, at temperatures below 190° C., followed by a Double Bubble orientation at an orientation ratio of 2.5:1 (TD) and 3.5:1 (LD), bath temperature of 98° C. and residence time of 0.5 min. The film was not irradiated.

### Film Properties

### Test Methods

TABLE 3

| Property | Unity | Instrument | Test method | Conditions |
|---|---|---|---|---|
| Free shrink | % | | ASTM D2732 | 85° C., |
| | | | | water |
| Gloss | G.U. | | ASTM D2457 | 60° |
| Elastic Modulus | Kg/cm² | | ASTM D882 | 23° C. |
| Tensile Strength | Kg/cm² | | ASTM D882 | 23° C. |
| Elongation at break | % | | ASTM D882 | 23° C. |
| Oxygen transmission | cc/m².day. | Mocon | ASTM F1927 | RH: 95% |
| rate OTR | atm | Oxtran | | in-85% |
| | | 2/20 | | out |
| Water vapour | g/m².day. | | ASTM E96/ | RH: 100% |
| transmission rate | atm | | E96M-15 water | in-85% |
| WVTR* | | | method | out** |
| Moisture vapour | g/m².day. | Mocon | ASTM F1249 | RH: 98% |
| transmission rate | atm | W700 | | in-0% |
| MVTR | | | | out |
| Carbon dioxide | cc/m².day. | Permatran | ASTM F2476 | RH: 0% |
| transmission rate | atm | C4/41 | | in-0% |
| CTR | | | | out |

*(sealant layer of the film vs water)
**15% delta RH (in and out in respect of the cup)
Free Shrink: it is the percent dimensional change in a 10 cm × 10 cm specimen of a selected heat; it has film when subjected to been measured following ASTM Standard Test Method D 2732, immersing the specimen for 5 seconds in a water bath heated at 85° C..
Gloss 60°: it has been evaluated following ASTM D2457. The average value of the measurements performed in longitudinal and transverse directions was reported.
Elastic modulus at 23° C.: it has been evaluated following ASTM D 882.
Tensile Strength and Elongation at break (ASTM D 882). Tensile strength represents the maximum tensile load per unit area of the original cross-section of the test specimen required to break it, expressed as kg/cm². Elongation at break represents the increase in length of the specimen, measured when the sample breaks expressed as percentage of the original length.

Measurements were performed with Instron tensile tester equipped with a load cell type CM (1-50 kg), in an environmental chamber set at 23° C., on specimens previously stored at 23° C. and 50% RH for minimum of 24 hours. Tensile and elongation measurements were recorded simultaneously and the reported results are the average values.

Seal strength: an internal test method was used to evaluate this property.

Transmission properties: Oxygen transmission rate OTR, water vapour transmission rate WVTR, Moisture vapour transmission rate MVTR, Carbon dioxide transmission rate CTR were evaluated according to the methods reported in Table 3 and under the temperatures reported in Table 4 below.

Unless otherwise stated, the values of RH expressed as In/Out % values refer to the humidity of the gas admixture in contact with one or with the other surface of the tested film. Typically the In surface is, if present, the sealant surface of the film.

In particular, for the OTR evaluation the nitrogen carrier gas with 95% of RH flows towards the seal surface (In) while the oxygen containing gas with 85% of RH is in contact with the other surface (Out).

In case of MVTR, water vapor (98% RH) is in contact with the sealant surface (in) while dried nitrogen (0% RH) flows towards the outer surface (Out).

The film of Example 1 and a commercial comparative film C1, marketed with the name of Pack-Age™ (three layers pouch of nylon, layers thickness of 8, 30 and 10 microns, total thickness of about 48 microns) for ripening semi-hard and hard cheese, were subjected to the test methods described above with the following results:

TABLE 4
gas transmission properties

| | | Tem- | Film | Film |
|---|---|---|---|---|
| Property | Test method | perature | Ex. 1 | C1 |
| OTR | ASTM F-1927 | 12° C. | 290 | 19 |
| OTR | ASTM F-1927 | 23° C. | 630 | — |
| CTR | ASTM F 2476 | 23° C. | 5000 | 84 |
| MVTR | ASTM F1249 | 38° C. | 590 | 481 |
| WVTR | ASTM E96/ | 10° C. | 23 | — |
| | E96M-15 water method | | | |

The film of the invention is much more permeable than the comparative film, in particular in respect of oxygen and carbon dioxide.

TABLE 5
other properties

| Property | Unity | Film Ex. 1 | |
|---|---|---|---|
| Free Shrink | % | 24 | (LD) |
| | | 36 | (TD) |
| Elongation | % | 230 | (LD) |
| at break | | 330 | (TD) |
| Elastic | Kg/cm² | 2870 | (LD) |
| Modulus | | 2060 | (TD) |
| Tensile | Kg/cm² | 520 | (LD) |
| strength | | 450 | (TD) |

| | | |
|---|---|---|
| Gloss | GU | 83 |

### Seal Strength

The seal strength of the films of the invention and of comparative films was measured by sealing together the faced internal surfaces of a tubing of the film under test and then by measuring the force needed to separate the sealed samples.

Tubings were obtained from the extrusion runs (30 cm wide and 20 cm long).

The test was carried out by sealing the tubings, at different impulse times, and by measuring the seal strength on a dynamometer after a storage period at 23° C. and 50% RH of the sealed films of 24 hours.

### Equipment and Conditions

Vacuum sealing chamber machine with ultraseal (VS20 by Cryovac):
Seal bar length=90 cm
Round shape seal wire=2×1 mm
Pressure due to vacuum=4.0 kg/cm²
Force on the seal bar=1620 kg
KLC (kg/linear cm)=90

The impulse time has been increased in steps of 0.2 sec.

Cooling time is 2 sec (this is a stabilization time during which the two parts of the sealing bar stays closed onto the film to be sealed even if impulse is 0).

Sealing cycles were set in such a way to have three minutes of delay between one seal and the next to allow the sealing bar to cool down.

The sealing was made by placing the tubing in the center of the sealing bar and with the tubing LD (longitudinal direction) transversally (orthogonally) oriented with respect to the sealing bar main direction.

Ten adjacent specimens of 25.4 mm in width (i.e. one inch) and of about 10 cm of length, orthogonal and centered with respect to the sealing area, were cut from the each sealed tubing. Thirty specimens were tested for each condition.

The sealed specimens were stored at room temperature (23° C.) and 50% RH for 24 hours.

The measurement of the seal strength was effected with a dynamometer Instron 5564, with a crosshead speed of 30 cm/min. Each specimen (2.54 cm of width) was clamped within the jaws: one flap of the sample was clamped in the upper jaw, which is movable during the test while the other flap of the sample in the lower jaw which is fixed, in such a way that the seal is horizontally positioned at equal distance from the two jaws. The jaws separation before starting the test was 2 cm. The test was then started, the crosshead moved up until the seal was broken. The instrument recorded the force needed to open the seal (the peak value of the recorded force was taken as seal strength and expressed in g/inch).

The conditions and the results of seal strength assessment for the film of Example 1 and for the comparative film C1 are reported in Table 6:

TABLE 6

| Sample | Film | Comparative |
|---|---|---|
| (clean conditions) | Ex. 1 | film C1 |
| 1 | | |
| Impulse Time (sec) | 0.4 | 0.4 |
| Seal Strength AVG (gf/in) | 1931 | 0 |
| Seal Strength STD | 104 | 0 |
| Comment | | no seal |
| 2 | | |
| Impulse Time (sec) | 0.6 | 0.6 |
| Seal Strength AVG (gf/in) | 3251 | 3553 |
| Seal Strength STD | 78 | 80 |
| 3 | | |
| Impulse Time (sec) | 0.8 | 0.8 |
| Seal Strength AVG (gf/in) | 3266 | 4293 |
| Seal Strength STD | 180 | 68 |
| 4 | | |
| Impulse Time (sec) | 1.0 | 1.0 |
| Seal Strength AVG (gf/in) | 3720 | 4318 |
| Seal Strength STD | 150 | 81 |

AVG average;
STD standard deviation

As can be seen, the film of the invention shows good seal performance even at very low sealing times, for instance at 0.4 sec. Under this condition, the comparative film does not seal.

### Example 2: Ripening Test on Pecorino

Thirty-six rounds of Pecorino Sardo of about 2.5-3.0 kg (flat cylindrical shape size: 10-11 cm of height and diameter of 18-20 cm) with 70 days of natural ripening at 11.5° C. and 75% RH were used.

The rounds were packed with end-seal bags (350 mm wide and 500 mm long) made from the film of Example 1.

The rounds were placed into the bags and packages were prepared by using a vacuum chamber machine with the following settings: seal pressure 6.5 bar, cut pressure 2.8 bar, sealing time 2.5 sec, cutting time 2.5 sec., vacuum 6 mbar.

The obtained packages were stored at 11.5° C. and 74-75% of RH in a cell and subjected to weight control at 30, 60, 90, 100 and 120 days from the day of packaging.

On each detection of weight drop, all the rounds were turned upside down. The weight drop was evaluated by weighting the packaged round at each weight control and by comparing with the initial weight (as a percentage).

The percentage weight loss may be calculated according to the following formula

[(Wt−Wi)/Wi]×100

in which Wi is the initial weight of the packaged cheese and Wt is the weight at the time of detection during ripening.

At the end of the test (120 days), the presence of mold on the surface, the color and texture of the crust and of the structure of the cheese were also evaluated.

The ripened rounds had a deep yellow rind and a pale yellow firm cheese.

The film according to the invention showed satisfactory gas transmission performance, limiting the weight loss and preserving the characteristics of the product (consistency of the crust and structure of the cheese).

The Tests on Pecorino cheese showed for the packages made with the film of the invention (Ex. 1) a weight loss of −0.4% at 120 days, much less than natural weight loss, which generally is of about 10-12%.

### Example 3: Preservation Test on Taleggio

Purpose of this study was to evaluate the preservation of quality and peculiar features of Taleggio cheese during transport and commercialization (medium shipping time is about 120 days).

Forty rounds of Taleggio of about 2.5-3.0 kg (squared, size: 20 cm×20 cm×8-9 cm) after 50 days of ripening were used.

The rounds were individually packaged, either traditionally (Ex. 3a-3e, 5 rounds each) namely wrapped with a parchment and/or a pelure and placed in a cardboard box or according to the invention (Ex. 3f-3h, 5 rounds each) namely first wrapped with a parchment and/or a pelure, then enclosed in a vacuumized bag made of the film of example 1 and finally placed in a cardboard box. The packages were stored at +1° C./+6° C. and at 50% RH. The samples were observed and tasted by a panel of three persons, 75 days after packaging.

The packaging conditions and preliminary observations, after 75 days, are summarized in the following Table 7:

TABLE 7

| | External | | Weight | |
|---|---|---|---|---|
| Ex | bag | Packaging | loss | Notes |
| 3a | no | Printed paper + pelure | high | pelure tightly adhering to the rind with |
| | | | | difficult removal, too intense flavor |
| | | | | and taste (overripe) |
| 3b | no | PE coated parchment + pelure | in line* | moist rind, soft cheese, light growth of |
| | | | | surface mold, flavor in line * |
| 3c | no | Quartirolo paper + pelure | in line* | product with lightly moist crust, soft |
| | | | | cheese, light growth of surface mold, |
| | | | | flavor in line* |
| 3d | no | paper | high | wrapping attached to the rind with |
| | | | | difficult removal, intense flavor |
| 3e | no | parchment + pelure | in line* | lightly moist crust, soft paste, light |
| | | | | growth of surface mold, flavor in line* |
| 3f | Inv | PE coated parchment + | low | moist product, very soft cheese and |
| | | pelure + bag | | fermentation inside with detachment |
| | | | | of the rind, fruity aroma and taste |
| 3g | Inv | PE coated parchment + bag | low | moist product, very soft cheese and |
| | | | | fermentation inside with detachments, |
| | | | | fruity aroma and taste |
| 3h | Inv | parchment + pelure + bag | low | product with smooth and soft texture, |
| | | | | standard taste and flavor, no difficult |
| | | | | removal of pelure |

Inv: storage in a bag made of the film of Ex. 1 of the invention;
no: comparative storage with traditional packaging (shelf life)-without any bag;
PE: polyethylene;
*: in line with a product at 75 days of shelf life.

The preliminary data reported in Table 7 showed that the preservation method according to the invention advantageously maintains consistency of the cheese, microflora of the rind, taste and flavor of the product for 15 days beyond the standard shelf life of 60 days in parchment and pelure, with minimal weight loss. Furthermore, the method allowed an easy removal of the wrapping, without any adhesion to the rounds.

The performance of sample 3h was particularly good: shelf life of the packaged product was monitored up to 100 days with excellent results in terms of texture, flavor, optimal product conservation and preservation of weight (55% of dry matter).

In conclusion, the film of the invention can provide strong benefits during the cheese aging or storing process, in particular of hard cheese ripening.

In fact, it improves the quality of the cheese, in terms of more natural cheese ripening than vacuum maturation, providing cheese with rind and closer to traditional look. Further, it increases the product yield compared with natural cheese maturation.

This method, thanks to the specific gas and water transmission properties and to preferably taut packages, allows a reduction in the salting treatments during ripening, as it prevents mold growth.

Preliminary studies at a Pecorino producer indicated that 2 cycles of salting could be avoided in the meanwhile obtaining a ripened product with taste and appearance very similar to that of a natural ripened Pecorino.

Finally, for cheese Taleggio-like (washed-rind, smear-ripened cheese) preliminary data demonstrate a significant extension of shelf life, which can be particularly advantageous in case of shipping by sea.

1) A biodegradable film for cheese ripening or preservation characterized by
an OTR (Oxygen Transmission Rate) from 200 to 450 cc/m²·day·atm, (measured at 12° C., 95% in 85% out of Relative Humidity according to ASTM F1927),
a MVTR (Moisture Vapor Transmission Rate) from 500 to 900 g/m²·day·atm, (measured at 38° C., 98% in-0% out % of Relative Humidity according to ASTM F1249), and
a CTR (Carbon dioxide Transmission Rate) from 2000 to 6000 cc/m²·day·atm (measured at 23° C., 0% in-0% out of Relative Humidity according to ASTM F2476).

2) The film according to claim 1, which is an oriented biaxially oriented film.

3) The film according to claim 1 which is a heat-shrinkable film having a free shrink percentage in at least one of longitudinal direction (LD) and transverse direction (TD) of at least 20% (measured at 85° C. in water according to ASTM D2732).

4) The film according to claim 1 consisting of at least 50% by weight of biodegradable polymers.

5) The film according to claim 4 wherein said biodegradable polymers are selected the group of biodegradable polysaccharides, biodegradable (co)polyesters and their blends.

6) The film according to claim 4 wherein said biodegradable polymers are selected from the group comprising starches, polyhydroxybutyrate, polycaprolactone, polylactic acid esters, copolyesters of 1,4 butanediol, adipic acid and terephthalic acid.

7) The film according to claim 1 wherein the film consists of three layers having a structure AB/A, wherein the outer layers A comprise a biodegradable copolyester and the core layer B comprises a starch.

8) (canceled)

9) The film according to claim 7 wherein layer(s) A comprise a biodegradable polymer characterized by one or more of the following properties: a melting temperature from 110 to 120° C., a melt flow rate (MFR) from 2.7 to 4.9 g/10 min (measured at 190° C., 2,16 Kg), a Vicat softening point of 91° C. (method VST A/50, ISO 306:2004), a density from 1.25 to 1.27 g/cc.

10) The film according to claim 1 comprising at least 80% by weight in respect of the total weight of the film of a starch.

11) The film according to claim 1 characterized by an OTR from 220 to 360 cc/m²·day·atm, (measured at 12° C., 95% in-85% out Relative Humidity according to ASTM F1927),
a MVTR from 500 to 700 g/m²·day·atm, (measured at 38° C., 98% in-0% out Relative Humidity according to ASTM F1249),
a CTR from 3000 to 6000 cc/m²·day·atm (measured at 23° C., 0% in-0% out Relative Humidity according to ASTM F2476) and a free shrink percentage in at least one of the longitudinal LD and transverse TD directions of at least 25% (measured at 85° C. in water, according to ASTM D2732).

12) The film according to claim 1 further characterized by a WVTR (Water Vapor Transmission Rate) from 10 to 150 g/m²·day·atm (measured at 10° C., 100% in-85% out Relative Humidity, according to ASTM E96/E96M-15 water method)

13) The film according to claim 1 further characterized by
a total free shrink (sum of free shrink percentage in LD and TD ASTM D2732) of at least 20%; and/or
an elastic modulus (ASTM D882) from 2000 to 4000 Kg/cm² in at least one of the LD and TD directions; and/or
a tensile strength (ASTM D882) from 400 to 700 Kg/cm², in at least one of the LD and TD directions; and/or
an elongation at break (ASTM D882) from 200 to 350%, in at least one of the LD and TD directions; and/or
a gloss at 60° (ASTM D2457) of at least 75 GU.

14) (canceled)

15) (canceled)

16) A package for cheese ripening or preservation comprising a film an OTR (Oxygen Transmission Rate) from 200 to 450 cc/m2·day·atm, (measured at 12° C., 95% in 85% out of Relative Humidity according to ASTM F1927),
a MVTR (Moisture Vapor Transmission Rate) from 500 to 900 g/m2·day·atm, (measured at 38° C., 98% in-0% out % of Relative Humidity according to ASTM F1249), and
a CTR (Carbon dioxide Transmission Rate) from 2000 to 6000 cc/m2·day·atm (measured at 23° C., 0% in-0% out of Relative Humidity according to ASTM F2476),
the package and enclosing a cheese.

17) The package of claim 16, which is vacuumized and shrunk.

18) A method for cheese ripening and/or preservation, which comprises
(I) providing a cheese,
(ii) introducing the cheese into a flexible container comprising a biodegradable and containing an opening for receiving the cheese, or
packaging the cheese in a biodegradable optionally heat-shrinkable film according to a form-fill-seal packaging process,
(iii) closing, the package around the cheese, and
(iv) ripening and/or preserving the packaged cheese,
wherein said biodegradable optionally heat-shrinkable film is a film having an OTR (Oxygen Transmission Rate) from 200 to 450 cc/m2·day·atm, (measured at 12° C., 95% in 85% out of Relative Humidity according to ASTM F1927),
a MVTR (Moisture Vapor Transmission Rate) from 500 to 900 g/m2·day·atm, (measured at 38° C., 98% in-0% out % of Relative Humidity according to ASTM F1249), and
a CTR (Carbon dioxide Transmission Rate) from 2000 to 6000 cc/m2·day·atm (measured at 23° C., 0% in-0% out of Relative Humidity according to ASTM F2476).

19) The method according to claim 18 wherein the ripening or preserving step is performed at environmental relative humidity from 20 to 95% and at a temperature from 1 to 25° C.

20) (canceled)

21) The method of claim 18 wherein the preservation step is performed at environmental relative humidity from 50 to 70% and at a temperature from 1 to 6° C.

22) A method for cheese preservation according to claim 18 wherein
i) the cheese is a washed-rind smear ripened cheese;
ii) the cheese is wrapped into a paper wrapping before being introduced into the flexible container, and
iii) closing of the container is performed under vacuum.

23) The method of claim 22 wherein the paper wrapping comprises at least a pelure, placed in contact with the cheese, and an external wrapping paper.

24) (canceled)

25) (canceled)

26) (canceled)

27) (canceled)

28) (canceled)

29) The method of claim 18 wherein the flexible container is a heat shrinkable film and the step of (iii) closing the package around the cheese is performed under vacuum.
